(19) United States
(12) Patent Application Publication
(10) Pub. No.: US 2026/0030570 A1
(43) Pub. Date: Jan. 29, 2026

(54) SYSTEM AND METHOD FOR INDICATING STATUS OF TASKS ASSIGNED TO WORK MACHINES

(71) Applicant: Caterpillar Paving Products Inc., Brooklyn Park, MN (US)

(72) Inventor: Matthew Thomas Hanson, St Louis Park, MN (US)

(73) Assignee: Caterpillar Paving Products Inc., Brooklyn Park, MN (US)

(21) Appl. No.: 18/782,119

(22) Filed: Jul. 24, 2024

(51) Int. Cl. G06Q 10/0631; B60Q 1/50

(52) U.S. Cl. CPC G06Q 10/063114; B60Q 1/5035; B60Q 1/543

(57) ABSTRACT

A system for indicating a status of a task assigned to a work machine on the work machine is described. The system includes an indicating device configured to be mounted to a mounting surface of the work machine and a controller. The indicating device includes a display portion viewable from an outside of the work machine. The controller is configured to receive first data corresponding to the task, determine one or more sub-systems of the work machine needed to execute the task based on the first data, and compute second data based on a usage of the one or more sub-systems during an execution of the task. The controller is configured to calculate a completion data of the task by comparing the second data with the first data and instruct the indicating device to display the completion data as the status of the task on the display portion.

### TECHNICAL FIELD

The present disclosure relates to a work machine which may perform one or more tasks at a worksite. More particularly, the present disclosure relates to a system and a method for visibly indicating task completion information on the work machine, during an execution of the task.

### BACKGROUND

Work machines, e.g., autonomous work machines, are utilized for many tasks, including those related to mining, earthmoving, and/or other industrial activities. In some scenarios, a site operator, who may be physically present at the worksite, is required to supervise the operations of the work machines at the worksite. By doing so, the site operator may keep track of a status of a task being performed by the work machines. However, the site operator may have no or limited access to the controls and systems of the work machines, making tracking the status difficult.

Korean Patent Publication Number 101369222 describes a system and a method for measuring work time required for construction machinery.

### SUMMARY OF THE INVENTION

In an aspect, the present disclosure relates to a system for indicating a status of a task assigned to a work machine on the work machine. The system includes an indicating device configured to be mounted to a mounting surface of the work machine and a controller. The indicating device includes a display portion viewable from an outside of the work machine. The controller is configured to receive first data corresponding to the task and determine one or more sub-systems of the work machine needed to execute the task based on the first data. Further, the controller is configured to compute second data based on a usage of the one or more sub-systems during an execution of the task and calculate a completion data of the task by comparing the second data with the first data. The controller is further configured to instruct the indicating device to display the completion data as the status of the task on the display portion.

In another aspect, the present disclosure relates to a method for indicating a status of a task assigned to a work machine on the work machine. The method includes mounting an indicating device to a mounting surface of the work machine. The indicating device includes a display portion viewable from an outside of the work machine. The method further includes using a controller to receive first data corresponding to the task and determine one or more sub-systems of the work machine needed to execute the task based on the first data. Further, the method includes using the controller to compute second data based on a usage of the one or more sub-systems during an execution of the task, calculate a completion data of the task by comparing the second data with the first data, and instruct the indicating device to display the completion data as the status of the task on the display portion.

In yet another aspect, the present disclosure relates to a work machine. The work machine includes a mounting surface, a plurality of sub-systems selectively usable to execute one or more tasks assigned to the work machine, and a system for indicating a status of a task of the one or more tasks on the work machine. The system includes an indicating device mounted to the mounting surface and a controller. The indicating device includes a display portion viewable from an outside of the work machine. The controller is configured to receive first data corresponding to the task and determine one or more sub-systems of the plurality of sub-systems needed to execute the task based on the first data. The controller is further configured to compute second data based on a usage of the one or more sub-systems during an execution of the task, calculate a completion data of the task by comparing the second data with the first data, and instruct the indicating device to display the completion data as the status of the task on the display portion.

### BRIEF DESCRIPTION

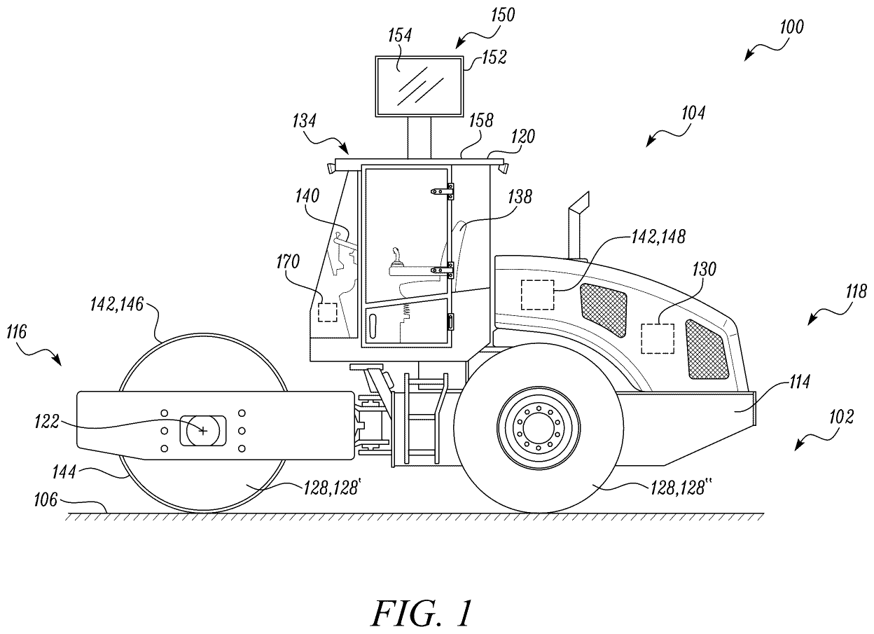

FIG. 1 illustrates a work machine performing a task at a worksite, in accordance with an embodiment of the present disclosure;

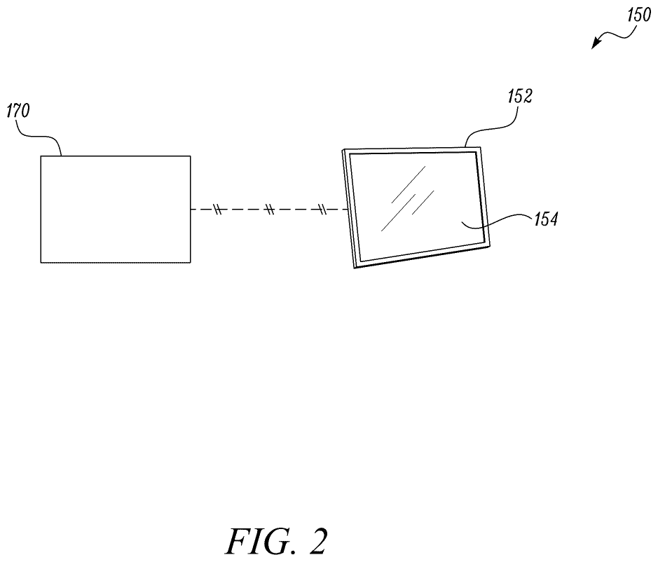

FIG. 2 illustrates a system for indicating a status of the task assigned to the work machine, in accordance with an embodiment of the present disclosure;

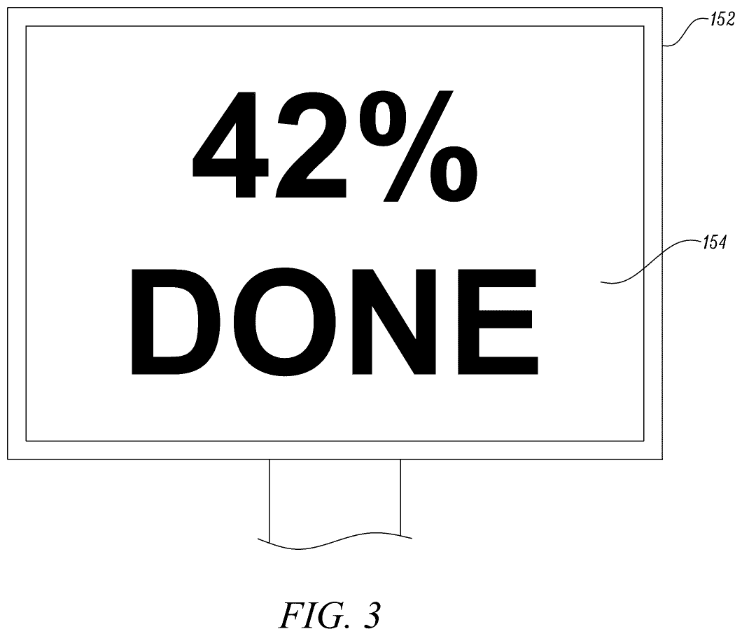

FIGS. 3 through 5 illustrate an indicating device displaying the status of the task assigned to the work machine, in accordance with an embodiment of the present disclosure; and

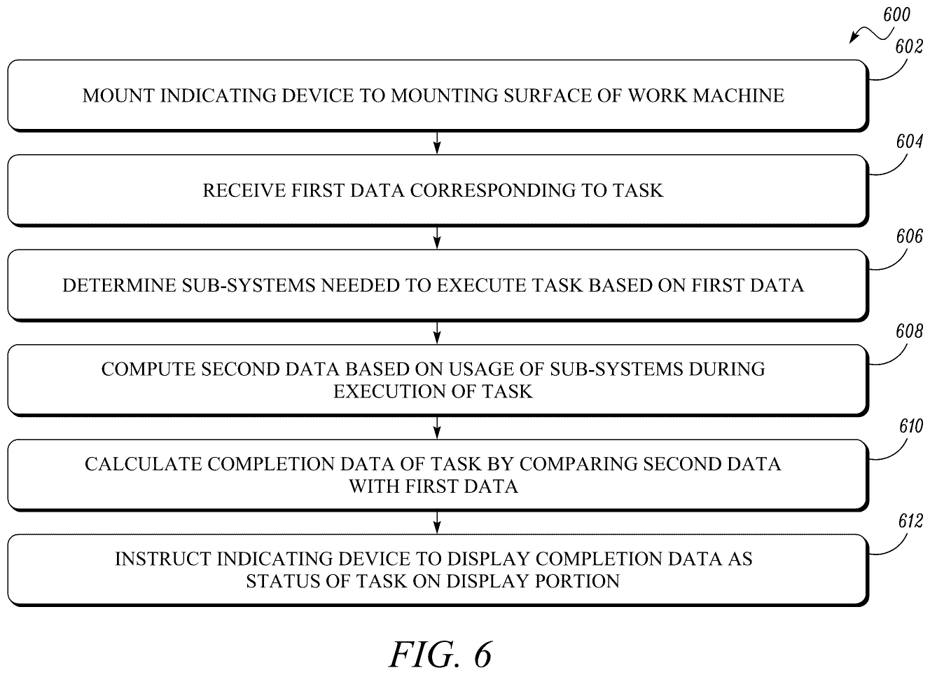

FIG. 6 is an exemplary method for indicating the status of the task assigned to the work machine on the work machine of FIG. 1, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIG. 1, a work machine 100 is described. The work machine 100 may be any autonomous or manually controlled work machine configured to perform one or more tasks at a worksite 102. For the purposes of the present disclosure, the work machine 100 has been described to include a compactor 104.

As shown in FIG. 1, the compactor 104 may be configured to perform a variety of compaction operations at the worksite 102. For example, the compactor 104 may be configured to grade and/or compact a work surface 106 of the worksite 102 by performing multiple passes (referred to as discrete passes) on the work surface 106. The work surface 106 may include soil, gravel, landfill waste, asphalt, combinations thereof, or any other surface material known in the art, and which may benefit from a compaction process.

The compactor 104 may include a frame 114 and traction devices 128 coupled to the frame 114. One traction device 128′ may be positioned towards a forward end 116 of the compactor 104 while another traction device 128″ may be positioned towards a rear end 118 of the compactor 104. The traction devices 128 may be operatively coupled to a power source 130 (e.g., a reciprocating piston internal combustion engine, a gas turbine engine, an electric motor, a battery, and/or any other prime mover known in the art) for transfer of power from the power source 130 to the traction devices 128. In so doing, the compactor 104 may be propelled and/or moved over the work surface 106 during operations. The traction devices 128 may include one or more of wheels, crawler tracks, a drum, or any other land-based propulsion device known in the art. As exemplarily shown in FIG. 1, the traction device 128′ may correspond to a drum (see discussions towards a drum 146 below), which may also serve as a compaction implement of the compactor 104 and which may compact the work surface 106 (e.g., through a rolling engagement of the drum 146 with the work surface 106) as the work machine 100 moves over the work surface 106. The traction device 128″ may correspond to a wheel.

The compactor 104 may include a cab 134 configured to accommodate one or more operators of the compactor 104. The cab 134 may include a seat 138 and one or more control devices 140. The one or more control devices 140 may include a steering mechanism, a speed/throttle input, a console, a data display, a network telemetry link, combinations thereof, or any other input or output device known in the art to benefit operation of the compactor 104.

The compactor 104 may include one or more sub-systems 142 selectively usable to execute one or more tasks assigned to the compactor 104. For example, the sub-systems 142 may include an implement system having the aforenoted drum 146. The drum 146 may be cylindrical in structure and may define an outer operational surface 144 defining an outer operational surface area. Further, the outer operational surface 144 may define a radius extending from an axis of rotation 122 of the drum 146 to the outer operational surface 144. Although not limited, the outer operational surface 144 of the drum 146 may be a smooth surface and/or may include any other drum surface structure known in the art, e.g., the outer operational surface 144 may include protrusions typically applied on a drum of a landfill compactor.

As part of further examples of the sub-systems 142, the sub-systems 142 may include a global positioning system (GPS) 148 for obtaining a location of the compactor 104 at the worksite 102. The utilization of the GPS 148 for obtaining the location of the compactor 104 is exemplary and that the compactor 104 may optionally, or additionally, include a component of global navigation satellite system (GNSS) or one or more location sensors to obtain the location of the compactor 104, as well.

Although the work machine 100 is described as a compactor 104, the work machine 100 is not limited to the compactor 104 and may include any other work machine such as, an excavator, a haul truck, a mining machine, a dozer, a loader, and the like machines, having similar sub-systems for execution of tasks. Further, one or more aspects of the compactor 104 may be applied to the other work machines indicated above.

As shown in FIGS. 1 and 2, the work machine 100 may include a system 150 for indicating a status of a task of the one or more tasks assigned to the work machine 100 on the work machine 100. In accordance with various embodiments, the status may indicate a progress of the task assigned to the work machine 100. For example, the status may correspond to at least one of a percentage of completion of the task, a percentage of the task remaining to be completed, and/or a time remaining to complete the task.

The system 150 includes an indicating device 152 mounted to a mounting surface 158 (shown in FIG. 1) of the work machine 100. The mounting surface 158, as shown in FIG. 1, may correspond to an outer overhead surface or a roof 120 of the cab 134 of the work machine 100. Although not shown, the mounting surface 158 may correspond to any surface, e.g., defined on any outer panel of the work machine 100.

Referring back to FIGS. 1 and 2, the indicating device 152 may include a display portion 154 viewable from an outside of the work machine 100. The display portion 154 may be configured to display data associated with the tasks executed by the work machine 100. For example, the display portion 154 may be configured to display the status of the task assigned to the work machine 100. The display portion 154 of the indicating device 152 may be positioned such that the data displayed on the display portion 154 can be visually recognized and/or comprehended with relative ease from the work machine's outside environment, specifically, by a site operator at the worksite 102 stationed at the outside environment. Although not limited, the display portion 154 may include one or more of a digital display, a gauge with a pivoting arm, a light projector, and a plurality of lights.

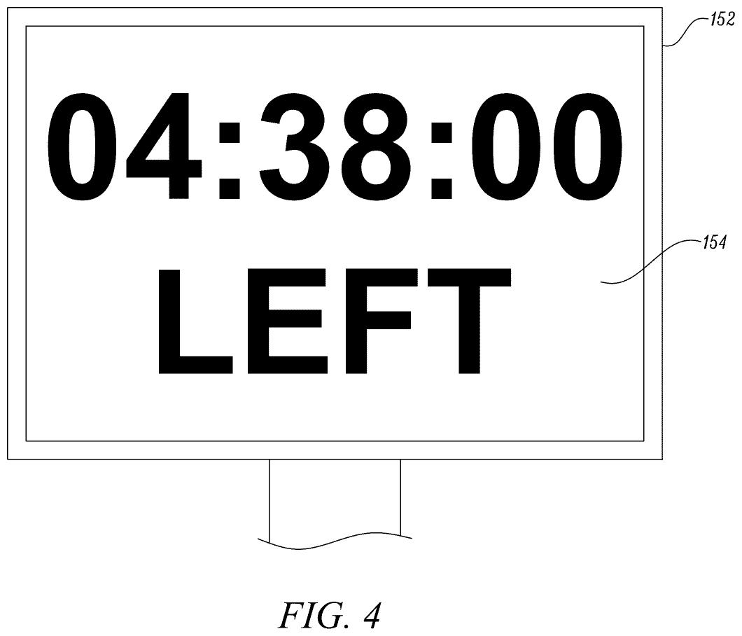

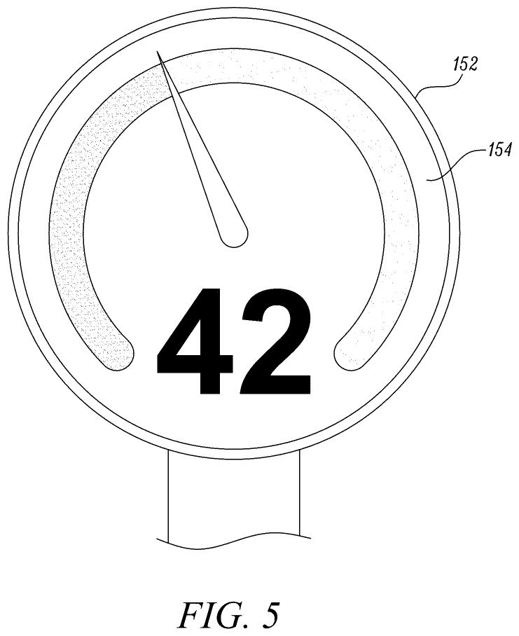

In an exemplary embodiment, as shown in FIG. 3, the display portion 154 may be a digital display configured to display the status of the task, for example, the percentage of completion of the task. In another exemplary embodiment, as shown in FIG. 4, the display portion 154 may be a light projector configured to display the status, for example, the time remaining to complete the task. In yet another exemplary embodiment, as shown in FIG. 5, the display portion 154 may be a gauge with a pivoting arm configured to display the status, for example, the percentage of completion of the task. It will be appreciated that the embodiments shown in FIGS. 3 through 5 are exemplary in nature and that the display portion 154 may be configured to represent the data associated with the status of the task assigned to the work machine 100 in various formats, depending on the requirements of the site operator. The examples illustrated and/or discussed by way of the embodiments shown in FIGS. 3 through 5 are not intended to be exhaustive. For example, the display portion 154 may include a plurality of lights, and the lighting of the lights may change depending on the completion percentage.

The system 150 may include a controller 170. The controller 170 may be operatively coupled (e.g., wirelessly or by a wired connection) to the indicating device 152. The controller 170 may be configured to receive the task(s) from onboard or offboard the work machine 100. The tasks may include first data and second data. The first data may be detailed as a “work plan” or “Task Plan” and may include first data corresponding to the task assigned to the work machine 100. For example, the first data may correspond to a total number of passes scheduled for the task assigned to the work machine 100, in the case the work machine 100 includes the compactor 104. The controller 170 may be configured to receive the first data from an operator stationed in the cab 134 or any remote device (in case of an autonomous work machine).

The controller 170 may be configured to determine one or more sub-systems 142 of the work machine 100 needed to execute the task based on the first data. For example, when the first data corresponds to the total number of passes (e.g., in the case of the compactor 104) scheduled for the task assigned to the work machine 100, the controller 170 may be configured to determine the GPS 148 as the sub-system 142 needed to execute the task.

The second data is used to determine the completion of that plan, and the controller 170 may be further configured to compute the second data based on a usage of the sub-systems 142 during an execution of the task. For example, the second data may correspond to a number of passes executed by the work machine 100 during the execution of the task or since a beginning of an execution of the task. As an example, the controller 170 may be configured to compute the usage or the number of passes executed by the work machine 100 during the execution of the task by tracking the location of the work machine 100 based on location data received from the GPS 148 to compute the second data. In some embodiments, the passes may be discrete and the controller 170 may be configured to compute the number of passes executed by the work machine 100 by matching the location data of the work machine 100 with a virtual map of the worksite 102 that indicates the total number of passes.

The controller 170 may be configured to calculate a completion data of the task by comparing the second data with the first data. To this end, the controller 170 may calculate the completion data based on a comparison of the number of passes executed by the work machine 100 during the execution of the task with the total number of passes scheduled for the task. As an example (referred to as a first example), if the first data or the total number of passes exemplarily correspond to a hundred (100) discrete passes, and the second data or the number of passes executed by the work machine 100 corresponded to forty-two (42) passes, the controller 170 may compare the second data with the first data by dividing the second data with the first data to obtain a quotient, e.g., in turn arriving at a forty-two (42)% completion data of the task assigned to the work machine 100.

In some embodiments, the completion data may correspond to the time remaining to complete the task. In such cases, the controller 170 may be configured to determine the time remaining to complete the task based on a comparison of a time lapsed during the execution of the task and a total time needed to execute the task deduced based on the first data. For example, when the first data corresponds to the total number of passes scheduled for the task assigned to the work machine 100, the controller 170 may determine that the total time needed to execute the task based on the total number of the passes and a time taken to execute one pass. The time taken to execute the pass may be pre-configured into the controller 170 by an operator. In some embodiments, the total time needed to execute the task may also depend on the variation in the speed of the work machine 100 and other operational parameters of the work machine 100. In this regard, when the total time needed to complete the task by the work machine 100 is determined considering a predefined average speed (e.g., 20 Km/hr) (kilometers/hour) of the work machine 100 and if the work machine 100 is operating at a speed greater than the predefined average speed, the total time taken to complete the task may also change (i.e., be reduced).

In some embodiments, the time remaining to complete the task may be obtained by comparing the total time needed with the completion data. For example, and referring to the first example described above, if the completion data were 42% and the total time needed were 8 hours, the time remaining to complete the task may be arrived at by determining a remaining task percentage (i.e. 58% in this case) and then obtaining a 58% of the eight (8) hours, which equals four (4) hours and thirty-eight (38) minutes.

In an exemplary embodiment, when the work machine 100 is a compactor 104, the first data may correspond to a total area to be compacted as part of the task and the second data may correspond to an area compacted by the compactor 104 during the execution of the task. In such cases, the first data may be predetermined data, and as an example, may be pre-configured into the controller 170 by an operator. For the second data, the controller 170 may be configured to determine the drum 146 of the compactor 104 as the sub-system 142 needed to execute the task. For example, the controller 170 is configured to compute the area compacted by the drum 146 during the execution of the task based on the data associated with one or more of operational and structural parameters of the drum 146. For example, the controller 170 may be configured to compute the area compacted by the drum 146 during the execution of the task by obtaining a product of the outer operational surface area of the drum 146 and a number of rotations of the drum 146 during the execution of the task. In accordance with various embodiments, the controller 170 may be configured to calculate the completion data based on a comparison of the area compacted by the compactor 104 during the execution of the task with the total area to be compacted for the task. As an example, if the first data or the total area to be compacted exemplarily correspond to a ten thousand (10,000) square meters, and the second data or the area compacted by the work machine 100 corresponded to forty-two hundred (4200) square meters, the controller 170 may compare the second data with the first data by dividing the second data with the first data to obtain a quotient, e.g., in turn arriving at a forty-two (42)% (percentage) completion data of the task assigned to the work machine 100.

In an exemplary embodiment, when the work machine 100 is an excavator, the first data may correspond to a total weight of a material bank to be excavated as part of the task and the second data may be calculated by computing a weight of the material moved from the material bank by a bucket of the excavator during the execution of the task.

Once the completion data of the task is calculated by the controller 170, the controller 170 may be configured to instruct the indicating device 152 to display the completion data as the status of the task on the display portion 154. For example, as shown in FIGS. 3 through 5, the status may correspond to at least one of the percentage of completion of the task, the percentage of the task remaining to be completed, and/or the time remaining to complete the task.

The controller 170 may be one or more processor, a microprocessor, a microcontroller, an electronic control module (ECM), an electronic control unit (ECU), or any other suitable means for calculating the completion data of the task assigned to the work machine 100. The controller 170 may be implemented using one or more controller technologies, such as Application Specific Integrated Circuit (ASIC), Reduced Instruction Set Computing (RISC) technology, Complex Instruction Set Computing (CISC) technology or any other similar technology now known or developed in the future. The controller 170 may be positioned in the work machine 100 or at a remote location from the work machine 100.

### INDUSTRIAL APPLICABILITY

FIG. 6 describes an exemplary method 600 for indicating the status of the task assigned to the work machine 100 on the work machine 100. The method 600 includes, at step 602, mounting the indicating device 152 to the mounting surface 158 of the work machine 100. Further, at step 604, the method 600 includes using the controller 170 to receive the first data corresponding to the task. At step 606, the controller 170 is used to determine the sub-system 142 of the work machine 100 needed to execute the task based on the first data. At step 608, the controller 170 is used to compute the second data based on the usage of the sub-systems 142 during the execution of the task. The controller 170 is used to calculate the completion data of the task by comparing the second data with the first data at step 610 and instruct the indicating device 152 to display the completion data as the status of the task on the display portion 154 at step 612.

The system 150 and the method 600 of the present disclosure allow the site operators to keep track of the status of the task assigned to the work machine 100. By mounting the indicating device 152 on the work machine 100 in a manner that the display portion 154 of the indicating device 152 is viewable from the outside of the work machine 100 and by displaying the completion data as the status of the task on the display portion 154, the status of the task can be easily accessed by the site operators for better tracking of the work performed on the worksite 102, thus more easily and efficiently achieving worksite productivity targets and further optimizing fleet management.

What is claimed is:

1. A system for indicating a status of a task assigned to a work machine on the work machine, the system comprising:
an indicating device configured to be mounted to a mounting surface of the work machine, the indicating device including a display portion viewable from an outside of the work machine; and
a controller configured to:
receive first data corresponding to the task;
determine one or more sub-systems of the work machine needed to execute the task based on the first data;
compute second data based on a usage of the one or more sub-systems during an execution of the task;
calculate a completion data of the task by comparing the second data with the first data; and
instruct the indicating device to display the completion data as the status of the task on the display portion.

2. The system of claim 1, wherein the work machine includes a compactor configured to grade and compact a surface of a worksite by performing multiple discrete passes on the surface, and further wherein the first data corresponds to a total number of passes scheduled for the task and the second data corresponds to a number of passes executed by the work machine during the execution of the task.

3. The system of claim 2, wherein the one or more sub-systems include a global positioning system (GPS) for obtaining a location of the work machine and wherein the controller is configured to:
compute the number of passes executed by the work machine during the execution of the task by tracking the location of the work machine to compute the second data; and
calculate the completion data based on a comparison of the number of passes executed by the work machine during the execution of the task with the total number of passes scheduled for the task.

4. The system of claim 1, wherein the work machine includes a compactor, and further wherein the first data corresponds to a total area to be compacted as part of the task and the second data corresponds to an area compacted by the compactor during the execution of the task.

5. The system of claim 4, wherein the one or more sub-systems include a drum of the compactor and wherein the controller is configured to:
compute the area compacted by the drum during the execution of the task based on the data associated with one or more of operational and structural parameters of the drum; and
calculate the completion data based on a comparison of the area compacted by the work machine during the execution of the task with the total area to be compacted for the task.

6. The system of claim 5, wherein the controller is configured to compute the area compacted by the drum during the execution of the task by obtaining a product of an outer operational surface area of the drum and a number of rotations of the drum during the execution of the task.

7. The system of claim 1, wherein the status corresponds to at least one of: a percentage of completion of the task or a percentage of the task remaining to be completed.

8. The system of claim 1, wherein the status corresponds to a time remaining to complete the task, and wherein the controller is configured to determine the time remaining to complete the task based on a comparison of a time lapsed during the execution of the task and a total time needed to execute the task deduced based on the first data.

9. The system of claim 1, wherein the display portion includes one or more of a digital display, a gauge with a pivoting arm, and a light projector.

10. A method for indicating a status of a task assigned to a work machine on the work machine, the method comprising:
mounting an indicating device to a mounting surface of the work machine, the indicating device including a display portion viewable from an outside of the work machine;
using a controller to:
receive first data corresponding to the task;
determine one or more sub-systems of the work machine needed to execute the task based on the first data;
compute second data based on a usage of the one or more sub-systems during an execution of the task;
calculate a completion data of the task by comparing the second data with the first data; and
instruct the indicating device to display the completion data as the status of the task on the display portion.

11. The method of claim 10, wherein the work machine includes a compactor configured to grade and compact a surface of a worksite by performing multiple discrete passes on the surface, and further wherein the first data corresponds to a total number of passes scheduled for the task and the second data corresponds to a number of passes executed by the work machine during the execution of the task.

12. The method of claim 11, wherein the one or more sub-systems include a global positioning system (GPS) for obtaining a location of the work machine and wherein the method further includes:
computing, by the controller, the number of passes executed by the work machine during the execution of the task by tracking the location of the work machine to compute the second data; and
calculating, by the controller, the completion data based on a comparison of the number of passes executed by the work machine during the execution of the task with the total number of passes scheduled for the task.

13. The method of claim 10, wherein the work machine includes a compactor, and further wherein the first data corresponds to a total area to be compacted as part of the task and the second data corresponds to an area compacted by the compactor during the execution of the task.

14. The method of claim 13, wherein the one or more sub-systems include a drum of the compactor and wherein the method further includes:
computing, by the controller, the area compacted by the drum during the execution of the task based on the data associated with one or more of operational and structural parameters of the drum; and
calculating, by the controller, the completion data based on a comparison of the area compacted by the work machine during the execution of the task with the total area to be compacted for the task.

15. The method of claim 14, wherein computing the area compacted by the drum during the execution of the task includes obtaining a product of an outer operational surface area of the drum and a number of rotations of the drum during the execution of the task.

16. The method of claim 10, wherein the status corresponds to at least one of: a percentage of completion of the task or a percentage of the task remaining to be completed.

17. The method of claim 10, wherein the status corresponds to a time remaining to complete the task, and wherein the method further includes:
determining, by the controller, the time remaining to complete the task based on a comparison of a time lapsed during the execution of the task and a total time needed to execute the task deduced based on the first data.

18. The method of claim 10, wherein the display portion includes one or more of a digital display, a gauge with a pivoting arm, and a light projector.

19. A work machine comprising:
a mounting surface;
a plurality of sub-systems selectively usable to execute one or more tasks assigned to the work machine; and
a system for indicating a status of a task of the one or more tasks on the work machine, the system including:
an indicating device mounted to the mounting surface, the indicating device including a display portion viewable from an outside of the work machine; and
a controller configured to:
receive first data corresponding to the task;
determine one or more sub-systems of the plurality of sub-systems needed to execute the task based on the first data;
compute second data based on a usage of the one or more sub-systems during an execution of the task;
calculate a completion data of the task by comparing the second data with the first data; and
instruct the indicating device to display the completion data as the status of the task on the display portion.

20. The work machine of claim 19, wherein the display portion includes one or more of a digital display, a gauge with a pivoting arm, and a light projector.
